(19) United States
(12) Patent Application Publication
(10) Pub. No.: US 2021/0253162 A1
(43) Pub. Date: Aug. 19, 2021

(54) VEHICLE DIG LOCK SYSTEM

(71) Applicants: Eric R. Thompson, Lake Orion, MI (US); Colin M. Cole, Oxford, MI (US); Aleksander Tonkovich, Keego Harbor, MI (US)

(72) Inventors: Eric R. Thompson, Lake Orion, MI (US); Colin M. Cole, Oxford, MI (US); Aleksander Tonkovich, Keego Harbor, MI (US)

(21) Appl. No.: 17/176,688

(22) Filed: Feb. 16, 2021

Related U.S. Application Data
(60) Provisional application No. 62/978,059, filed on Feb. 18, 2020.

(51) Int. Cl. B62D 6/00; B60T 8/24; B62D 7/15; B62D 15/02

(52) U.S. Cl. CPC B62D 6/007; B60T 8/246; B60T 2260/022; B62D 15/025; B62D 7/159

(57) ABSTRACT

A vehicle includes a propulsion system configured to selectively drive at least one wheel of a plurality of wheels, a brake system configured to selectively brake at least one wheel of the plurality of wheels, and a dig lock controller in signal communication with the propulsion system and the brake system. The dig lock controller is configured to, based on a driver request, selectively perform a vehicle rotating dig lock operation by braking one wheel of the plurality of wheels while driving at least one other wheel of the plurality of wheels to move the vehicle laterally about a pivot point at least partially defined by the braked wheel.

### CROSS REFERENCE TO RELATED APPLICATION

This application claims the benefit of U.S. Provisional Application No. 62/978,059, filed Feb. 18, 2020, the contents of which are incorporated herein by reference thereto.

### FIELD

The present application relates generally to vehicles and, more particularly, systems and methods for performing a vehicle pivoting dig lock operation.

### BACKGROUND

A vehicle is typically limited by the turning circle of the steering system while the vehicle is rolling. In some off-road maneuvers, it is desirable for the vehicle to have a tighter turning radius than what is available on a stock vehicle, for example, if an obstacle prevents the vehicle from moving in a forward direction. However, typical vehicles are unable to move laterally to avoid obstacles or perform tight turning off-road maneuvers. In order to provide tighter turning, some vehicles include systems using a rear brake to drag a tire in order to help the vehicle make sharper turns, but such systems have limited driver control and only allow for slightly sharper than normal turns. Accordingly, there is a desire for improvement in the relevant art.

### SUMMARY

In accordance with one example aspect of the invention, a vehicle is provided. The vehicle includes a propulsion system configured to selectively drive at least one wheel of a plurality of wheels, a brake system configured to selectively brake at least one wheel of the plurality of wheels, and a dig lock controller in signal communication with the propulsion system and the brake system. The dig lock controller is configured to, based on a driver request, selectively perform a vehicle rotating dig lock operation by braking one wheel of the plurality of wheels while driving at least one other wheel of the plurality of wheels to move the vehicle laterally about a pivot point at least partially defined by the braked wheel.

In addition the foregoing, the described vehicle may include one or more of the following features: wherein the controller is configured to perform a Front Right Dig operation by braking a right rear wheel of the plurality of wheels and driving front wheels of the plurality of wheels, to thereby move a front of the vehicle laterally rightward; wherein the controller disables propulsive torque to rear wheels of the plurality of wheels during the Front Right Dig operation; wherein the controller is configured to perform a Front Left Dig operation by braking a left rear wheel of the plurality of wheels and driving front wheels of the plurality of wheels, to thereby move a front of the vehicle laterally leftward; and wherein the controller disables propulsive torque to rear wheels of the plurality of wheels during the Front Left Dig operation.

In addition the foregoing, the described vehicle may include one or more of the following features: wherein the controller is configured to perform a Rear Left Dig operation by braking a front right wheel of the plurality of wheels and driving rear wheels of the plurality of wheels, to thereby move a rear of the vehicle laterally leftward; wherein the controller disables propulsive torque to front wheels of the plurality of wheels during the Rear Left Dig operation; wherein the controller is configured to perform a Rear Right Dig operation by braking a front left wheel of the plurality of wheels and driving rear wheels of the plurality of wheels, to thereby move a rear of the vehicle laterally rightward; wherein the controller disables propulsive torque to front wheels of the plurality of wheels during a the Rear Right Dig operation.

In addition the foregoing, the described vehicle may include one or more of the following features: an off-road mode switch, wherein the off-road mode switch must be activated in order to perform the dig lock operation; a steering wheel in signal communication with the dig lock controller, wherein the dig lock controller performs the dig lock in a direction based at least in part on a left or right orientation of the steering wheel; a steering angle input switch in signal communication with the dig lock controller, wherein the dig lock controller performs the dig lock in a direction based at least in part on a selection of the steering angle input switch; wherein the steering angle input switch includes a front dig switch, wherein the dig lock controller is configured to perform a front dig operation based at least in part on activation of the front dig switch, and a rear dig switch, wherein the dig lock controller is configured to perform a rear dig operation based at least in part on activation of the rear dig switch; a user interface in signal communication with the dig lock controller, wherein the user interface is configured to display a soft button for a user to initiate the dig lock operation; and wherein the controller is configured to bias torque to a front axle of the vehicle or a rear axle of the vehicle during the dig lock operation based on which wheel is the braked wheel.

In accordance with another example aspect of the invention, a method of performing a vehicle rotating dig lock operation on a vehicle having a plurality of wheels is provided. The method includes receiving, at a controller, a request for a dig lock operation, and initiating the dig lock operation by braking one wheel of the plurality of wheels while driving at least one other wheel of the plurality of wheels to move the vehicle laterally about a pivot point at least partially defined by the braked wheel.

In addition the foregoing, the described method may include one or more of the following features: temporarily disabling propulsive torque to the rear wheels when a rear wheel is braked during the dig lock operation, and temporarily disabling propulsive torque to the front wheels when a front wheel is braked during the dig lock operation; preventing initiation of the dig lock operation until an off-road switch disposed within the vehicle is selected; and performing a crab walk motion of the vehicle by alternating front and rear digs in the same direction to move the vehicle laterally in that direction.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example vehicle drivetrain in accordance with the principles of the present application;

FIG. 2 is a schematic diagram of an example dig lock system of the vehicle shown in FIG. 1, in accordance with the principles of the present application;

FIG. 3 is a flow control diagram of an example front dig operation of the dig lock system, in accordance with the principles of the present application;

FIG. 4 is a flow control diagram of an example rear dig operation of the dig lock system, in accordance with the principles of the present application;

FIG. 5 is a schematic diagram of a vehicle performing an example Front Right Dig operation, in accordance with the principles of the present application;

FIG. 6 is a schematic diagram of a vehicle performing an example Front Left Dig operation, in accordance with the principles of the present application;

FIG. 7 is a schematic diagram of a vehicle performing an example Rear Left Dig operation, in accordance with the principles of the present application; and

FIG. 8 is a schematic diagram of a vehicle performing an example Rear Right Dig operation, in accordance with the principles of the present application.

### DETAILED DESCRIPTION

According to the principles of the present application, systems and methods are described for performing a vehicle pivoting dig operation. In the example embodiments, a dig lock system is configured to enable the vehicle to rotate around one tire as a pivot point to achieve a tighter turning circle and even turn 360° in place. Such an operation may be performed with any of the vehicle's tires. In one example, a dig lock controller (e.g., dig lock ECU) is configured to interface with drivetrain and braking systems to drive/brake each wheel independently. Additionally, the dig lock controller is configured to perform a crab walk motion of the vehicle by alternating front and rear digs in the same direction. For example, the vehicle can be moved to the right laterally by performing a right front dig followed by a right rear dig and so on until the desired distance to the right is achieved.

In some examples, the dig lock system achieves rotational motion (e.g., when the vehicle is stopped) by locking up the brake on one tire to create a pivot point on the vehicle while turning the other tires at variable speeds. The net effect is the vehicle making sharp turns using the braked tire as the pivot point. The system can use inputs such as, for example, steering angle, accelerator and brake, and front/rear dig buttons to send signals to the dig lock controller. The dig lock controller then sends appropriate signals to the stability control/braking system and the drive train (propulsion system) controller to move the vehicle.

By allowing a driver to modulate throttle, brake, and steering the dig lock system enables the driver to manually control the degree that the vehicle pivots. Additionally, the dig lock system enables the vehicle to turn a full circle without moving forward. Moreover, the dig lock system enables the driver to move just the front or back of the vehicle laterally to get around obstacles, for example, via fore/aft propulsive torque control to the wheels. As a result, the driver would be able to crab walk the vehicle laterally to move around obstacles. Accordingly, the dig lock system enables direct propulsive torque exclusively to the appropriate wheels for enabling maximum rotational or lateral motion.

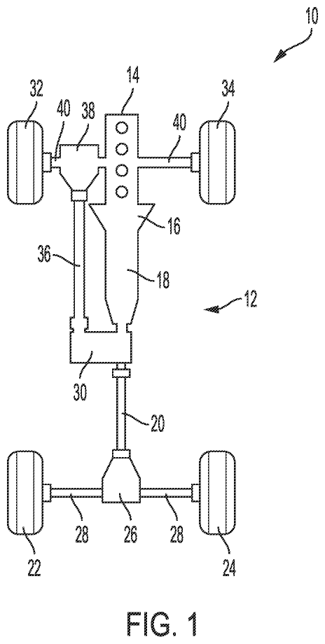

With initial reference to FIG. 1, a vehicle 10 in accordance with the principles of the present disclosure is illustrated. In the example embodiment, vehicle 10 includes a propulsion system 12 that generally includes an internal combustion engine 14, a clutch or torque converter 16, and a transmission 18. Reciprocating motion of the engine 14 is converted into rotational motion via torque converter 16 and transmitted to a drive shaft 20 via the transmission 18. Rotational motion of the drive shaft 20 is transferred to rear wheels 22, 24 via a rear differential 26 and rear drive axles 28. A transfer case 30 is configured to transfer rotational motion to front wheels 32, 34 via a front drive shaft 36, front differential 38, and front drive axles 40. In some examples, the transfer case 30 includes a shifting mechanism (e.g., shift fork) configured to selectively disengage the rear axles 28 and/or the front axles 40 from the propulsion system 12.

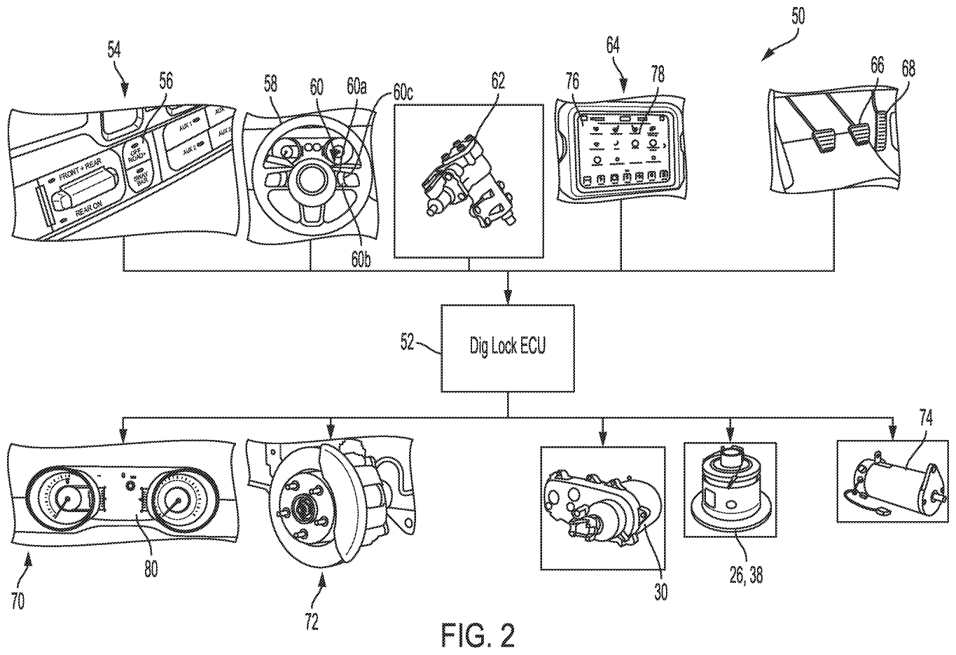

With additional reference to FIG. 2, vehicle 10 further includes a dig lock system 50 having a dig lock controller 52 configured to enable vehicle 10 to perform one or more dig and lateral movements. In the illustrated example, dig lock controller 52 is in signal communication with a plurality of vehicle systems/components including: an instrument panel 54 having an “off-road” mode switch 56, a steering wheel 58 with a steering angle input switches 60, a steering controller 62, a display 64, a brake pedal 66 and accelerator pedal 68, an instrument panel cluster 70, a braking system 72, transfer case 30, rear and front differentials 26, 28, and optionally an electric motor 74.

In the example embodiment, off-road mode switch 56 is configured to switch vehicle 10 between an on-road mode and an off-road mode. In the example implementation, off-road mode switch 56 must first be activated before dig lock system 50 can be activated. The steering wheel 58 is configured to control the direction of the dig operation by orienting the steering wheel 58 in the direction of the desired dig before initiation thereof. The steering wheel 58 additionally includes one or more steering angle input switches 60 (e.g., buttons, paddle shifters) utilized to activate front dig, rear dig, or lateral movement operations and provide steering angle input to control which tire is braked while doing a dig/movement. For example, input switches 60 may include a front dig switch 60a, a rear dig switch 60b, and a lateral dig switch 60c. The steering controller 62 is configured to control which tire is braked while doing a dig/movement.

In the example embodiment, the wheel braking and dig lock can be initiated and performed automatically or manually. For automatic operation, display 64 includes a user interface or touch screen 76 configured to display a soft button 78 for a user to automatically activate a dig lock mode and/or a brake lock mode (as opposed to manual operation). Soft button 78 enables the user to direct the dig lock controller 52 to automatically brake lock a designated wheel depending on which input switch 60 is selected, and subsequently automatically enter the dig lock mode and perform the dig lock operation.

If manual control of the dig lock and brake lock is desired, the driver can utilize the brake pedal 66 and accelerator pedal 68 as inputs to control the dig/movement. For example, when the brake pedal 66 is pressed, variable braking pressure is applied to a particular wheel depending on which input switch 60 is selected, and the accelerator 68 is subsequently operated to power the designated driving wheels to thereby perform the dig lock operation.

In the example embodiment, the instrument panel cluster 70 includes a display 80 configured to display a status and/or diagnostic message from the dig lock system 50. The brake system 72 is configured to selectively apply braking to one or more of the vehicle wheels based at least in part on steering angle input switches 60 and steering angle of steering wheel 58. The transfer case 30 is utilized to selectively turn on/off the front axles 40 and/or rear axles 28 when performing front digs, rear digs, and/or lateral movement. The front and rear differentials 38, 26 are utilized to direct torque to the appropriate tire during the dig/movement. The electric motor(s) 74 are operatively coupled to the vehicle wheels and may be utilized to selectively rotate one or more wheels to perform the dig/movement operations when vehicle 10 is equipped with an electric powertrain (not shown).

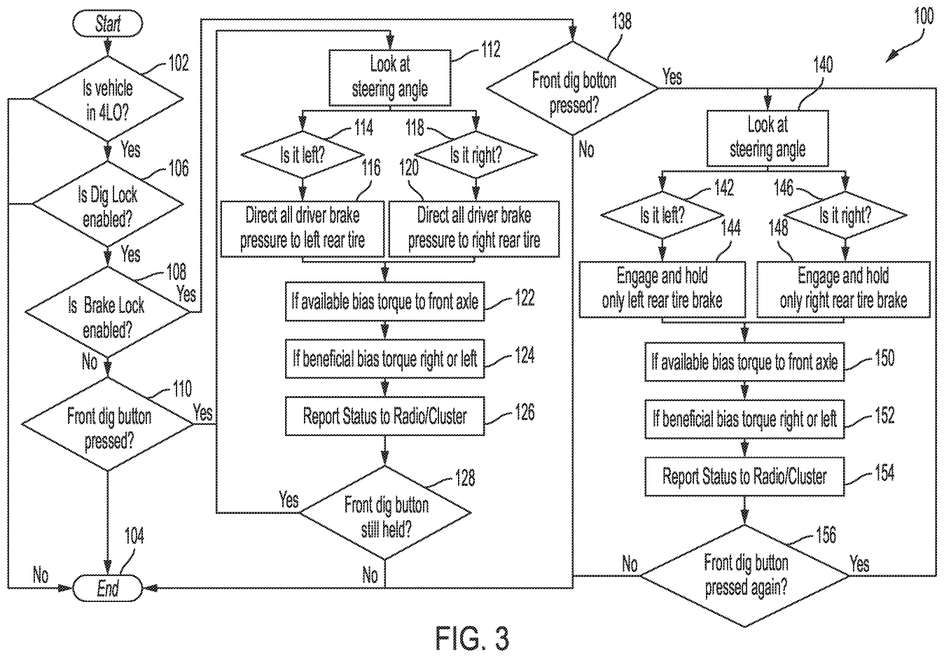

FIG. 3 illustrates one example method 100 of operating dig lock system 50 to perform a Front Dig operation when the engine 14 is on, the driver is present, and the vehicle 10 is in gear. In the example embodiment, the method begins at step 102 and dig lock controller 52 determines if vehicle 10 is in a predetermined gear such as, for example, four-wheel-drive LO. If no, control proceeds to step 104 and the operation ends. If yes, control proceeds to step 106 and dig lock controller 52 determines if dig lock is enabled via selection of the off-road mode switch 56. If no, control proceeds to step 104. If yes, at step 108, dig lock controller 52 determines if automatic brake lock is enabled, for example, via a button, switch, touch screen 76, etc. If no, control proceeds to step 110 for manual brake lock using brake/accelerator pedals 66, 68. If yes, control proceeds to step 138 for automatic brake lock and dig movement, as discussed herein in more detail.

At step 110, dig lock controller 52 determines if front dig switch 60a is activated. If no, control proceeds to step 104. If yes, control proceeds to step 112 and dig lock controller 52 determines a steering wheel angle. If steering angle is leftward (step 114), control proceeds to step 116 and dig lock controller 52 directs all driver brake pressure (from brake pedal 66) to the left rear wheel 22. If steering angle is rightward (step 118), control proceeds to step 120 and dig lock controller 52 directs all driver brake pressure to the right rear wheel 24. Control then proceeds to step 122 and dig lock controller 52 biases torque to front axles 40, for example, based on torque request from accelerator pedal 68. At step 124, if desired, dig lock controller 52 is configured to bias torque right or/or left, for example, to improve performance. At step 126, dig lock controller 52 reports the dig lock operational status to display 64 and/or the instrument panel cluster 70. At step 128, dig lock controller 52 determines if the front dig is still requested via front dig switch 60a (e.g., still held/activated). If yes, control returns to step 112 for further dig lock operations. If no, control proceeds to step 104 and the system ends the dig lock operations.

At step 138, dig lock controller 52 determines if the front dig switch 60a is activated. If no, control proceeds to step 104. If yes, at step 140, dig lock controller 52 determines the steering wheel angle. If the steering wheel angle is leftward (step 142), control proceeds to step 144 and dig lock controller 52 automatically engages and holds the left rear wheel brake, for example, via steering controller 62 and braking system 72. If the steering wheel angle is rightward (step 146), control proceeds to step 148 and dig lock controller 52 automatically engages and holds the right rear wheel brake. Control proceeds to step 150 and dig lock controller 52 automatically biases torque to the front axle 40 if available. At step 152, if desired, dig lock controller 52 is configured to bias torque right or/or left, for example, to improve performance. At step 154, dig lock controller 52 reports the dig lock operational status to display 64 and/or the instrument panel cluster 70. At step 156, dig lock controller 52 determines if the front dig is still requested via front dig switch 60a (e.g., still held/activated). If yes, control returns to step 140 for further dig lock operation. If no, control proceeds to step 104 and the system ends the dig lock operation.

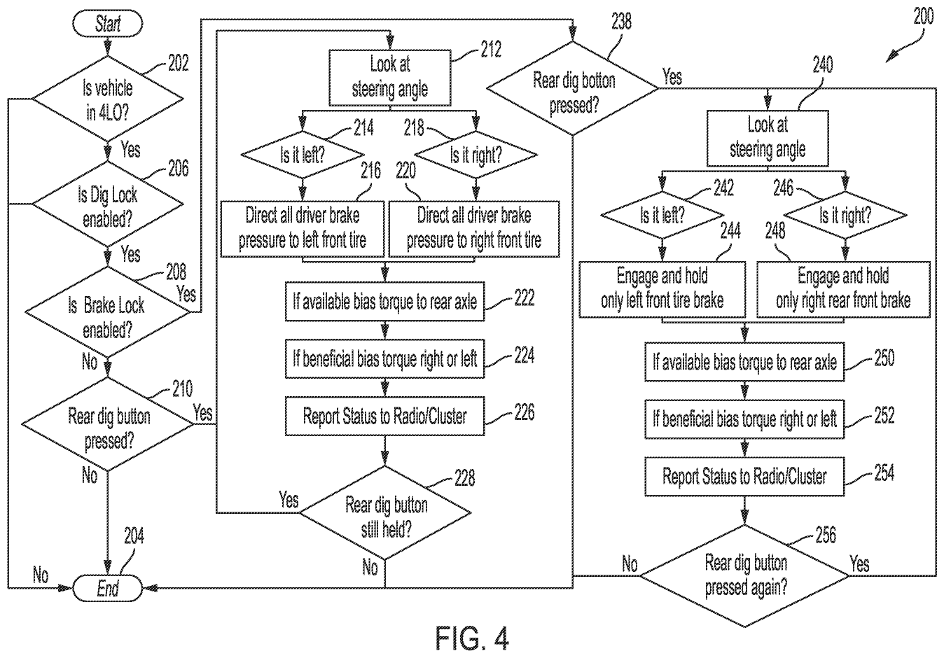

FIG. 4 illustrates one example method 200 of operating dig lock system 50 to perform a Rear Dig operation when engine 14 is on, driver is present, and vehicle 10 is in gear. In the example embodiment, the method begins at step 202 and dig lock controller 52 determines if vehicle 10 is in four-wheel-drive LO. If no, control proceeds to step 204 and the operation ends. If yes, control proceeds to step 206 and dig lock controller 52 determines if dig lock is enabled via selection of the off-road mode switch 56. If no, control proceeds to step 204. If yes, dig lock controller 52 determines if automatic brake lock is enabled at step 208. If no, control proceeds to step 210 for manual brake lock using brake/accelerator pedals 66, 68. If yes, control proceeds to step 238 for automatic brake lock and dig movement, as discussed herein in more detail.

At step 210, dig lock controller 52 determines if a rear dig switch 60b is activated. If no, control proceeds to step 204. If yes, control proceeds to step 212 and dig lock controller 52 determines a steering wheel angle. If the steering wheel angle is leftward (step 214), control proceeds to step 216 and dig lock controller 52 directs all driver brake pressure (from brake pedal 66) to the left front wheel 32. If steering angle is rightward (step 218), control proceeds to step 220 and dig lock controller 52 directs all driver brake pressure to the right front wheel 34. Control then proceeds to step 222 and dig lock controller 52 biases torque to rear axles 28, for example, based on torque request from accelerator pedal 68. At step 224, if desired, dig lock controller 52 is configured to bias torque right or/or left, for example, to improve performance. At step 226, dig lock controller 52 reports the dig lock operational status to display 64 and/or the instrument panel cluster 70. At step 228, dig lock controller 52 determines if the front dig is still requested via front dig switch 60b (e.g., still held/activated). If yes, control returns to step 212 for further dig lock operations. If no, control proceeds to step 204 and the system ends the dig lock operations.

At step 238, dig lock controller 52 determines if the rear dig switch 60b is activated. If no, control proceeds to step 204. If yes, at step 240, dig lock controller 52 determines the steering wheel angle. If the steering wheel angle is leftward (step 242), control proceeds to step 244 and dig lock controller 52 automatically engages and holds the left front wheel brake, for example, via steering controller 62 and braking system 72. If the steering wheel angle is rightward (step 246), control proceeds to step 248 and dig lock controller 52 automatically engages and holds the right front wheel brake. Control proceeds to step 250 and dig lock controller 52 automatically biases torque to the rear axles 28 if available. At step 252, if desired, dig lock controller 52 is configured to bias torque right or/or left, for example, to improve performance. At step 254, dig lock controller 52 reports the dig lock operational status to display 64 and/or the instrument panel cluster 70. At step 256, dig lock controller 52 determines if the front dig is still requested via front dig switch 60b (e.g., still held/activated). If yes, control returns to step 240 for further dig lock operation. If no, control proceeds to step 204 and the system ends the dig lock operation.

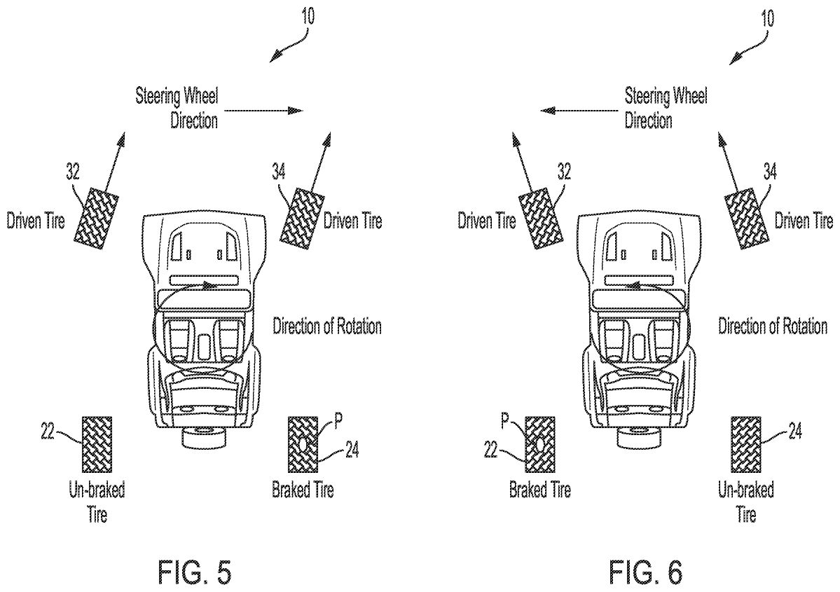

Turning now to FIGS. 5-8, schematic diagrams of example dig lock operations are shown and illustrated. In the example illustration, FIG. 5 depicts an example Front Right Dig operation where the right rear wheel 24 becomes a pivot point ‘P’ for rotation of vehicle 10 by braking the right rear wheel 24 and driving front wheels 32, 34. In this operation, the steering wheel 58 is directed rightward (from a neutral forward position) such that front wheels 32, 34 are oriented in a generally rightward direction. Dig lock controller 52 controls transfer case 30 to disable propulsion transfer to the rear wheels 22, 24 and subsequently drives the front wheels 32, 34, while the unbraked rear left wheel 22 rolls with the vehicle 10, thereby causing vehicle 10 to rotate clockwise about pivot point ‘P’ (as shown in FIG. 5). Accordingly, vehicle 10 moves generally laterally rightward utilizing the Front Right Dig operation.

FIG. 6 illustrates an example Front Left Dig operation where the left rear wheel 22 becomes a pivot point ‘P’ for rotation of the vehicle 10 by braking the left rear wheel 22 and driving front wheels 32, 34. In this operation, the steering wheel 58 is directed leftward (from neutral forward position) such that front wheels 32, 34 are oriented in a generally leftward direction. Dig lock controller 52 controls transfer case 30 to disable propulsion transfer to the rear wheels 22, 24 and subsequently drives the front wheels 32, 34, while the unbraked rear right wheel 24 rolls with the vehicle 10, thereby causing vehicle 10 to rotate counter-clockwise about pivot point ‘P’ (as shown in FIG. 6). Accordingly, vehicle 10 moves generally laterally leftward utilizing the Front Left Dig operation.

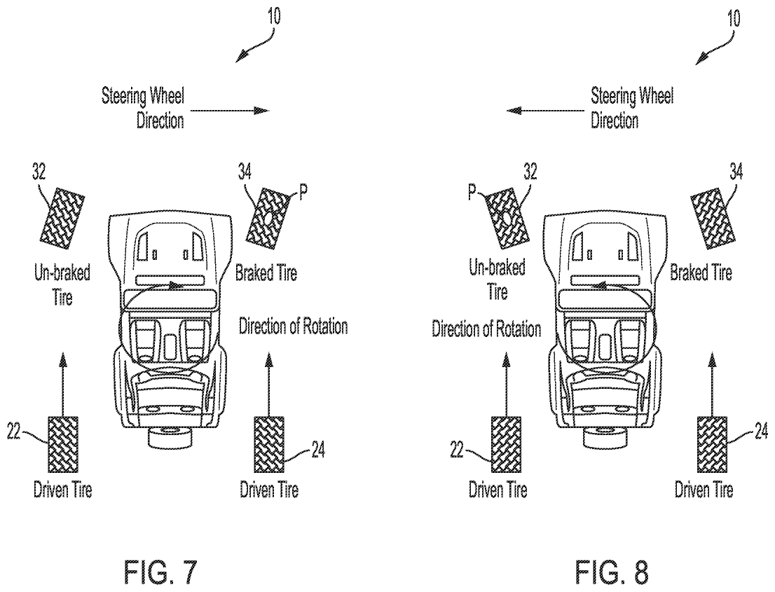

FIG. 7 illustrates an example Rear Left Dig operation where the right front wheel 34 becomes a pivot point ‘P’ for rotation of the vehicle 10 by braking the front right wheel 34 and driving rear wheels 22, 24. In this operation, the steering wheel 58 is directed rightward (from neutral forward position) such that front wheels 32, 34 are oriented in a generally rightward direction. Dig lock controller 52 controls transfer case 30 to disable propulsion transfer to the front wheels 32, 34 and subsequently drives the rear wheels 22, 24 while the unbraked left front wheel 32 rolls with the vehicle 10, thereby causing vehicle 10 to rotate clockwise about pivot point ‘P’ (as shown in FIG. 7). Accordingly, vehicle 10 moves generally laterally leftward utilizing the Rear Left Dig operation.

FIG. 8 illustrates an example Rear Right Dig operation where the left front wheel 32 becomes a pivot point ‘P’ for rotation of the vehicle 10 by braking the front left wheel 32 and driving rear wheels 22, 24. In this operation, the steering wheel 58 is directed leftward (from neutral forward position) such that front wheels 32, 34 are oriented in a generally leftward direction Dig lock controller 52 controls transfer case 30 to disable propulsion transfer to the front wheels 32, 34 and subsequently drives the rear wheels 22, 24 while the unbraked right front wheel 34 rolls with the vehicle 10, thereby causing vehicle 10 to rotate counter-clockwise about pivot point ‘P’ (as shown in FIG. 5). Accordingly, vehicle 10 moves generally laterally rightward utilizing the Rear Right Dig operation. Advantageously, dig lock controller 52 is configured to utilize various combinations of the Front Right Dig, Front Left Dig, Rear Left Dig, and/or Rear Right Dig operations to move vehicle 10 in a desired direction, for example, during off-road conditions when the area surrounding the vehicle is limited, there are obstructions that require side-to-side transverse movement, etc.

Described herein are systems and methods for performing pivoting dig movements of a vehicle. The system allows the driver to modulate the vehicle throttle, brake, and steering wheel to control a degree of vehicle pivot about a braked wheel while one or more of the other wheels are driven. Using fore/aft propulsive torque control to the wheels, the system enables the driver to move only the front or back of the vehicle laterally to get around obstacles, or even enable the vehicle to turn a full circle without moving forward. Accordingly, off-road driving and maneuverability are improved.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A vehicle, comprising:
a propulsion system configured to selectively drive at least one wheel of a plurality of wheels;
a brake system configured to selectively brake at least one wheel of the plurality of wheels; and
a dig lock controller in signal communication with the propulsion system and the brake system;
wherein the dig lock controller is configured to, based on a driver request, selectively perform a vehicle rotating dig lock operation by braking one wheel of the plurality of wheels while driving at least one other wheel of the plurality of wheels to move the vehicle laterally about a pivot point at least partially defined by the braked wheel.

2. The vehicle of claim 1, further comprising a steering wheel in signal communication with the dig lock controller, wherein the dig lock controller performs the dig lock operation in a direction based at least in part on a left or right orientation of the steering wheel.

3. The vehicle of claim 1, further comprising a steering angle input switch in signal communication with the dig lock controller, wherein the dig lock controller performs the dig lock operation in a direction based at least in part on a selection of the steering angle input switch.

4. The vehicle of claim 3, wherein the steering angle input switch comprises:
a front dig switch, wherein the dig lock controller is configured to perform a front dig operation based at least in part on activation of the front dig switch; and
a rear dig switch, wherein the dig lock controller is configured to perform a rear dig operation based at least in part on activation of the rear dig switch.

5. The vehicle of claim 1, wherein the controller is configured to bias torque to a front axle of the vehicle or a rear axle of the vehicle during the dig lock operation based on which wheel is the braked wheel.

6. The vehicle of claim 1, wherein the controller is configured to perform a front dig operation by braking a rear wheel of the plurality of wheels and driving front wheels of the plurality of wheels, and is configured to perform a rear did operation by braking a front wheel of the plurality of wheels and driving the rear wheels of the plurality of wheels; and
wherein the controller is configured to perform a lateral crab walk motion of the vehicle by alternating front and rear digs in the same direction to move the vehicle laterally in that direction.

7. The vehicle of claim 1, wherein the controller is configured to perform a front right dig operation by braking a right rear wheel of the plurality of wheels and driving front wheels of the plurality of wheels, to thereby move a front of the vehicle laterally rightward.

8. The vehicle of claim 7, wherein the controller disables propulsive torque to rear wheels of the plurality of wheels during the front right dig operation.

9. The vehicle of claim 1, wherein the controller is configured to perform a front left dig operation by braking a left rear wheel of the plurality of wheels and driving front wheels of the plurality of wheels, to thereby move a front of the vehicle laterally leftward.

10. The vehicle of claim 9, wherein the controller disables propulsive torque to rear wheels of the plurality of wheels during the front left dig operation.

11. The vehicle of claim 1, wherein the controller is configured to perform a rear left dig operation by braking a front right wheel of the plurality of wheels and driving rear wheels of the plurality of wheels, to thereby move a rear of the vehicle laterally leftward.

12. The vehicle of claim 11, wherein the controller disables propulsive torque to front wheels of the plurality of wheels during the rear left dig operation.

13. The vehicle of claim 1, further comprising an off-road mode switch, wherein the off-road mode switch must be activated in order to perform the dig lock operation.

14. The vehicle of claim 1, further comprising a user interface in signal communication with the dig lock controller, wherein the user interface is configured to display a soft button for a user to initiate the dig lock operation.

15. A method of performing a vehicle rotating dig lock operation on a vehicle having a plurality of wheels, the method comprising:
receiving, at a controller, a request for a dig lock operation; and
initiating the dig lock operation by braking one wheel of the plurality of wheels while driving at least one other wheel of the plurality of wheels to move the vehicle laterally about a pivot point at least partially defined by the braked wheel.

16. The method of claim 15, further comprising:
temporarily disabling propulsive torque to the rear wheels when a rear wheel is braked during the dig lock operation; and
temporarily disabling propulsive torque to the front wheels when a front wheel is braked during the dig lock operation.

17. The method of claim 16, further comprising performing a lateral crab walk motion of the vehicle by alternating between a front dig operation and a rear dig operation in a same direction to move the vehicle laterally in that direction,
wherein a front dig operation is performed by braking a rear wheel of the plurality of wheels and driving front wheels of the plurality of wheels, and
wherein the rear dig operation is performed by braking a front wheel of the plurality of wheels and driving the rear wheels of the plurality of wheels.

18. The method of claim 15, further comprising preventing initiation of the dig lock operation until an off-road switch disposed within the vehicle is selected.
